(19) United States
(12) Patent Application Publication
(10) Pub. No.: US 2010/0253495 A1
(43) Pub. Date: Oct. 7, 2010

(54) IN-VEHICLE IMAGE PROCESSING DEVICE, IMAGE PROCESSING METHOD AND MEMORY MEDIUM

(75) Inventors: Tadashi Asano, Gifu-shi (JP); Akira Fujimoto, Komaki-shi (JP); Yukihiro Matsuura, Nagoya-shi (JP); Yukihiko Yoshinaga, Kariya-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN SEIKI KABUSHIKI KAISHA, Kariya-shi, Aichi-ken (JP)

(21) Appl. No.: 12/679,241

(22) PCT Filed: Nov. 6, 2008
(86) PCT No.: PCT/JP2008/070197

§ 371 Date: Mar. 19, 2010

(30) Foreign Application Priority Data
Nov. 8, 2007 (JP) 2007-291069

(51) Int. Cl. B60Q 1/00; H04N 7/18

(52) U.S. Cl. 340/439; 348/77; 348/E07.085

(57) ABSTRACT

Every time a camera transmits a picked-up face image to an ECU, the ECU detects a face area from the transmitted face image, and corrects an exposure time so as to have brightness most appropriate to determine a facial direction and the condition of eyes at the detected face area. The corrected exposure time is notified to the camera, and the camera picks up an image of the face of a driver at the notified exposure time. Accordingly, the ECU analyzes a face image which is periodically picked up with the most appropriate brightness regardless of a change in an environment, and determines whether or not a driver is doing a hazardous driving.

### FIELD

The present invention relates to an in-vehicle image processing device which is connected to a camera that picks up images of a face of a driver in a vehicle, an image processing method and a computer-readable non-transitory tangible medium.

### BACKGROUND

Processes of reading the direction of a face and the condition of eyes from a face image of a driver to determine whether or not the driver is taking his/her eyes off a road or falling asleep while driving, and of alerting the driver as needed are executed.

For example, patent literature 1 (Unexamined Japanese Patent Application KOKAI Publication No. 2007-072628) discloses a technology of determining a facial direction and the level of confidence from a face image in order to determine the inattentive driving of a driver or the like. Application of such a technology enables determination of the inattentive driving of a driver with a high confidence level and appropriate alerting.

### SUMMARY

Luminous environment or the like for picking up an image of a driver changes continually as a vehicle travels. Accordingly, a face image may become too dark or halation may occur so that the analysis thereof becomes difficult, resulting in improper reading of face conditions (e.g., a facial direction, the direction of eyes, the opening/closing status of eyes). If such conditions continue, appropriate alerting may become difficult.

The present invention has been made in view of the foregoing circumstances, and it is an object of the present invention to determine a face condition appropriately regardless of a change in a luminous environment.

It is another object of the present invention to provide an in-vehicle image processing device and the like which can pick up an image of a face from which a face condition can be correctly read even if the luminous environment changes.

Furthermore, it is the other object of the present invention to enable acquisition of an image of a face appropriate for analysis regardless of a change in the luminous environment.

To achieve the foregoing objects, an in-vehicle image processing device according to the first aspect of the present invention comprises:

face image receiver which receives a picked-up image including a face of a driver from a camera;

face area detector which analyzes the image which is received by the face image receiver, and detects an area of a face which is included in the image;

brightness determiner which determines brightness of the face area which is detected by the face area detector;

camera controller which controls the camera in order to make brightness of a face area to be a predetermined level based on the brightness of the face area which is acquired by the brightness determiner; and

condition determiner which determines a condition of a driver using an image of a face area that the brightness of the face area which is detected by the face area detector is a predetermined level.

Preferably, the in-vehicle image processing device comprises alerter which outputs an alert based on a condition determined by the condition determiner.

The brightness determiner may add a heavier weight to a face area detected by the face area detector than other areas, and acquire a weighted average of brightness of an image.

The camera may periodically pick up an image of a driver and provide the picked-up image to the face image receiver, and

the camera controller may control an exposure amount of the camera in accordance with brightness determined by the brightness determiner.

The camera controller may shorten an exposure time of the camera or narrow a diameter of a diaphragm of the camera when brightness determined by the brightness determiner is larger than a first reference value, and may extend the exposure time of the camera or widen the diameter of the diaphragm of the camera when the brightness determined by the brightness determiner is smaller than a second reference value which is smaller than the first reference value.

The alerter may determine at least one of a facial direction, the direction of eyes, and the opening/closing status of eyes of a driver using an image of a face area which is detected by the face area detector, and may generate an alert based on a determination result.

To achieve the foregoing objects, an image processing method according to the second aspect of the present invention comprises:

a face image receiving step of receiving a picked-up image including a face of a driver from a camera;

a face area detecting step of analyzing the received image, and detecting an area of a face which is included in the image;

a brightness determining step of determining brightness of the area of the detected face;

a camera control step of controlling the camera in order to make brightness of a face area of an image to be a predetermined level based on the determined brightness; and

a condition determining step of determining a condition of a driver using an area of a face that the detected brightness of the face area is a predetermined level.

The brightness determining step may be carried out by adding a heavier weight to a face area detected in the face area detecting step than other areas, and by acquiring a weighted average of brightness of an image.

The face image receiving step may receive a picked-up image which is periodically picked-up by the camera, and

the camera control step may control an exposure amount of the camera in accordance with brightness determined in the brightness determining step.

The camera control step may shorten an exposure time of the camera or narrow a diameter of a diaphragm of the camera when brightness determined in the brightness determining step is larger than a first reference value, and may extend the exposure time of the camera or widen the diameter of the diaphragm of the camera when the determined brightness is smaller than a second reference value which is smaller than the first reference value.

To achieve the foregoing objects, a computer-readable non-transitory tangible medium, according to the third aspect of the present invention, stores a program controlling a computer to function as:

face image receiver which receives a picked-up image including a face of a driver from a camera;

face area detector which analyzes the image which is received by the face image receiver, and detects an area of a face which is included in the image;

brightness determiner which determines brightness of the face area which is detected by the face area detector;

camera controller which controls the camera in order to make brightness of a face area to be a predetermined level based on the brightness of the face area which is acquired by the brightness determiner; and

condition determines which determines a condition of a driver using an image of a face area that the brightness of the face area detected by the face area detector is a predetermined level.

The brightness determiner of the program may add a heavier weight to a face area detected by the face area detector than other areas, and acquire a weighted average of brightness of an image.

The face image receiver of the program may receive a picked-up image which is periodically picked-up by the camera, and

the camera controller of the program may control an exposure amount of the camera in accordance with brightness determined by the brightness determiner.

The camera controller of the program may shorten an exposure time of the camera or narrow a diameter of a diaphragm of the camera when brightness determined by the brightness determiner is larger than a first reference value, and extend the exposure time of the camera or widen the diameter of the diaphragm of the camera when the brightness determined by the brightness determiner is smaller than a second reference value which is smaller than the first reference value.

According to the present invention, it is possible to maintain the brightness of the face area of a face image in an appropriate value regardless of a change in an environment. Consequently, it becomes possible to determine a face condition of a driver by analyzing the face area of the image regardless of the change in the environment.

### BRIEF DESCRIPTION OF DRAWINGS

FIG. 1 is a block diagram of an in-vehicle image processing system according to an embodiment of the present invention;

FIG. 2 is a block diagram showing a structure of a camera and that of an ECU shown in FIG. 1;

FIG. 3A is a view showing the operator of a sobel filter for detecting a vertical edge;

FIG. 3B is a view showing the operator of a sobel filter for detecting a horizontal edge;

FIG. 3C is a view of data where a shading difference in a vertical direction is enhanced;

FIG. 3D is a view of data where a shading difference in a horizontal direction is enhanced;

FIG. 3E is a view showing data of the range of an optimum brightness and that of an exposure condition;

FIG. 4 is a flowchart for explaining an exposure control process;

FIG. 5 is a flowchart for explaining a face position determination process in the flowchart of FIG. 4;

FIG. 6 is a flowchart for explaining a primary process in the flowchart of FIG. 5;

FIG. 7 is a flowchart for explaining a face-both-ends detecting process in the flowchart of FIG. 5;

FIG. 8 is a flowchart for explaining a face-top-and-bottom-position detecting process in the flowchart of FIG. 5;

FIG. 9 is a flowchart for explaining an exposure time correction process in the flowchart of FIG. 4; and

FIG. 10 is a flowchart for explaining a driver alerting process.

### DETAILED DESCRIPTION

An explanation will be given of an in-vehicle image processing system 100 according to an embodiment of the present invention. The in-vehicle image processing system 100 picks up an image of a driver, determines a condition of the driver from the picked-up image, and alerts the driver as needed.

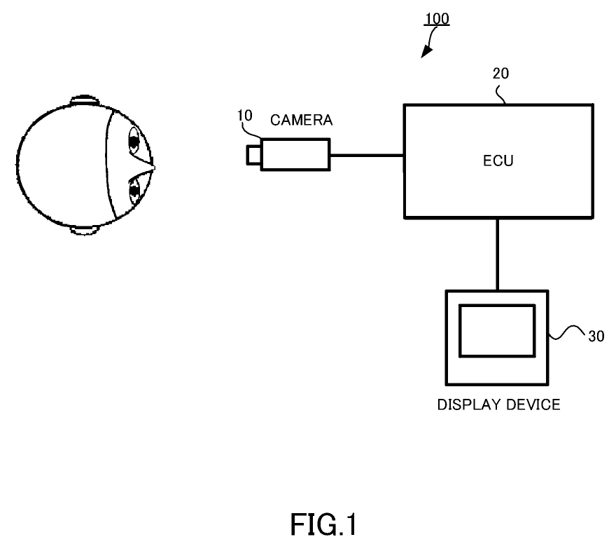

The in-vehicle image processing system 100 comprises, as shown in FIG. 1, a camera 10 that picks up an image of a driver and generates an image, an ECU (Engine Control Unit) 20 which is connected to the camera 10, and a display device 30 which is connected to the ECU 20.

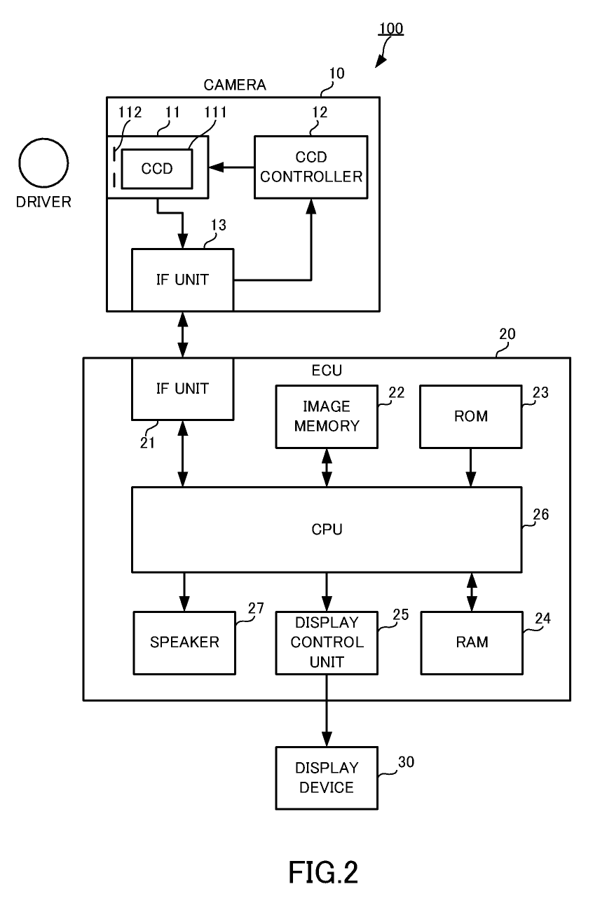

The camera 10 comprises, as shown in FIG. 2, an image-pickup unit 11, a CCD controller 12, and an IF unit 13.

The image-pickup unit 11 comprises a CCD (Charge Coupled Device) 111 and a diaphragm 112, and is controlled by the CCD controller 12 to periodically pick up an image of a face of a driver.

Note that an image of a face picked up by the image-pickup unit 11 includes not only the face of the driver, but also the background thereof.

The CCD controller 12 comprises a CPU (Central Processing Unit), a ROM (Read Only Memory), a RAM (Random Access Memory) and the like, uses the RAM as a work area, and controls the operation of the image-pickup unit 11 by running a control program stored in the ROM. For example, the CCD controller 12 controls image-pickup by the CCD 111 in the image-pickup unit 11, starting/terminating of an exposure, transferring of a picked-up image and the like. Moreover, the CCD controller 12 controls the diameter of the aperture of the diaphragm 112 (opening: aperture value).

The IF unit 13 is an interface which communicates with the ECU 20.

The ECU 20 is an electronic control unit which has a function, other than of controlling a whole vehicle, of detecting the position of a face (face area) from an image received from the camera 10, of calculating an exposure time for making an image to have an optimum brightness at the detected face area, and of instructing the exposure time to the CCD controller 12, and a function of detecting a hazardous driving, such as an inattentive driving and a drowsy driving, of the driver by analyzing the face image, and of alerting the driver.

The ECU 20 comprises an IF unit 21, an image memory 22, a ROM 23, a RAM 24, a display control unit 25, a CPU 26, and a speaker 27.

The IF unit 21 is an interface which communicates with the camera 10.

The ROM 23 stores a control program for controlling the operation of the CPU 26, and fixed data.

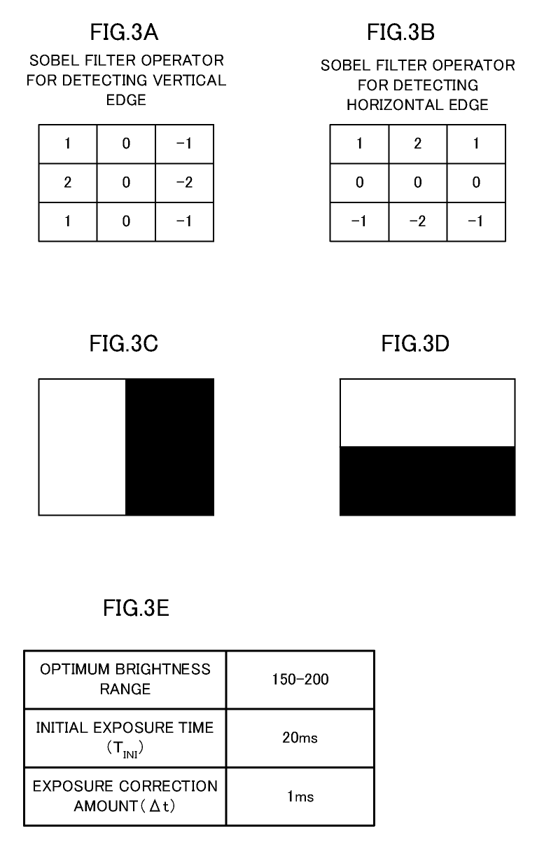

An example of the fixed data stored in the ROM 23 will be explained with reference to FIG. 3A to FIG. 3E.

The ROM 23 stores, as shown in FIG. 3A and FIG. 3B, operators of sobel filters for detecting a vertical edge and a horizontal edge, respectively. The sobel filter for detecting a vertical edge and the sobel filter for detecting a horizontal edge shown in FIG. 3A and FIG. 3B, respectively, are the operators to enhance a shading difference in a vertical direction and a shading difference in a horizontal direction shown in FIG. 3C and FIG. 3D, respectively.

Moreover, as shown in FIG. 3E, the ROM 23 stores information (an optimum brightness range) indicating the range of brightness most appropriate to determine a facial direction and the condition of eyes from a face image.

Furthermore, as shown in FIG. 3E, the ROM 23 stores a default exposure time (an initial exposure time (T_{INI})) of the camera 10, and a correcting amount of the exposure time (the exposure correction amount (Δt)).

The RAM 24 functions as a work area for the CPU 26.

Moreover, the RAM 24 stores an image-pickup time (an exposure time Tₑ) of the camera 10. The exposure time Tₑ is notified to the camera 10 by the CPU 26, and the camera 10 picks up an image at the exposure time Tₑ. Note that in an initial state, the initial exposure time T_{INI} is set as the exposure time Tₑ.

Furthermore, the RAM 24 records coordinates (x-coordinate, y-coordinate) of both ends of a face and top and bottom positions thereof detected from a face image. It becomes possible to specify the face area from the face image with these positional coordinates.

The display control unit 25 controls the display device 30 under the control of the CPU 26.

The CPU 26 controls the operation of the ECU 20 by reading out and running the control program from the ROM 23. Moreover, the CPU 26 detects a face area by analyzing a face image picked up by the camera 10, and executes a process (exposure control process) of controlling the exposure time of the camera 10 so as to make an image to have brightness most appropriate to determine a facial direction and the condition of eyes at the face area.

The speaker 27 outputs an alert to a driver doing a hazardous driving under the control of the CPU 26.

The display device 30 comprises an LCD (Liquid Crystal Display), a CRT (Cathode Ray Tube) or the like and displays a navigation image, an image for alerting and the like.

Next, an explanation will be given of the operation of the foregoing in-vehicle image processing system 100.

When the operation of the in-vehicle image processing system 100 starts as the user manipulates the system, the CCD controller 12 starts controlling the image-pickup unit 11.

More specifically, the CCD controller 12 controls starting/terminating of an exposure of the CCD 111 in the image-pickup unit 11 and transferring of a picked-up image by the CCD 111 in the image-pickup unit 11 in order to cause the CCD 111 to pick up an image for each predetermined timing (e.g., 1/30 second) at an exposure time Tₑ notified from the ECU 20.

The CCD 111 performs lithographic exposure for an instructed exposure time Tₑ under the control of the CCD controller 12, and picks up an image including an area of the face of a driver. The CCD 111 transmits the picked-up face image to the ECU 20 through the IF unit 13.

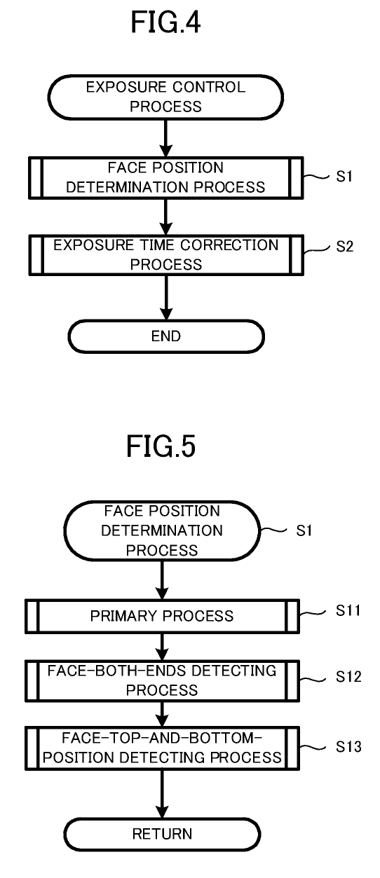

The CPU 26 of the ECU 20 starts the exposure control process shown in FIG. 4 every time receiving a face image picked up by the camera 10 through the IF unit 21.

First, the CPU 26 executes a face position determination process of determining a face position from the received face image (step S1).

As shown in FIG. 5, the face position determination process includes a primary process (step S11), a face-both-ends detecting process (step S12), and a face-top-and-bottom-position detecting process (step S13).

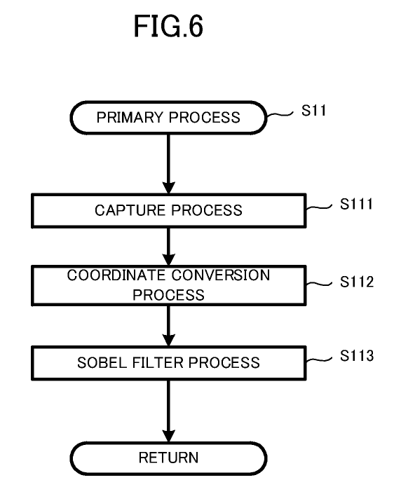

The primary process (step S11) includes, as shown in FIG. 6, a capture process (step S111), a coordinate conversion process (step S112), and a sobel filter process (step S113).

The capture process (step S111) is to store a face image of one frame received by the IF unit 21 in the image memory 22.

The coordinate conversion process (step S112) is to reduce the number of pixels of the face image in a processable level.

The sobel filter process (step S113) is to process the face image having undergone a coordinate conversion using the sobel filter for detecting a vertical edge (FIG. 3A) stored in the ROM 23 to enhance the vertical edge in the face image, and to process the face image having undergone the coordinate conversion using the sobel filter for detecting a horizontal edge (FIG. 3B) to enhance the horizontal edge in the face image.

Returning now to FIG. 5, the face-both-ends detecting process (step S12) is to specify lines making up both ends of the face for the processed face image processed by the operator for detecting the vertical edge, and an arbitrary conventional technique can be applied to this process.

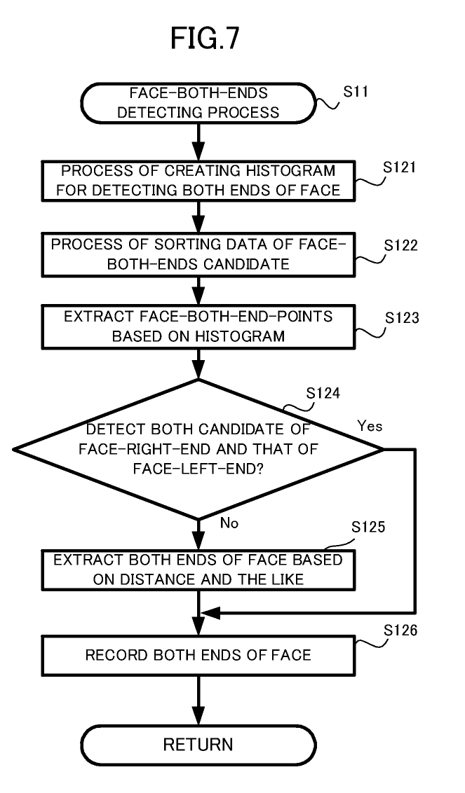

For example, as shown in FIG. 7, first, the CPU 26 executes a process of creating a histogram for detecting both ends of the face (step S121). The histogram creating process is to create a histogram by projecting values of individual pixels of the processed face image in the vertical direction.

Next, the CPU 26 extracts a predetermined number of histograms having a high peak value and sorts those (step S122), and extracts both left and right end points of the face based on the values of the histogram (step S123).

Next, the CPU 26 determines whether or not two end points (both left and right ends) are extracted (step S124). If two end points are extracted (step S124; Yes), the CPU 26 sets the extracted two points as left and right ends (x-coordinates) of the face, and records such coordinates in the RAM 24 (step S126).

Conversely, if two end points are not extracted (step S124; No), the CPU 26 extracts a combination of two points that a distance therebetween is a presumable space as the width of a human face (step S125). The CPU 26 sets the extracted combination of two points as left and right ends (x-coordinates) of the face, and records such coordinates in the RAM 24 (step S126).

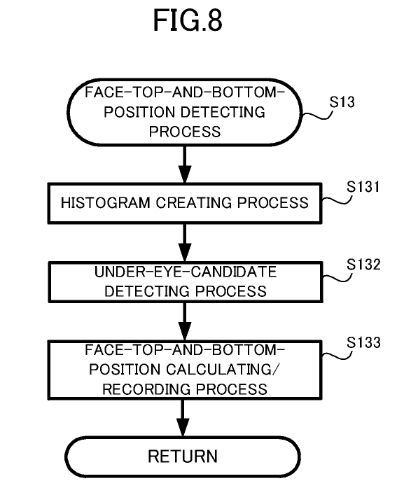

Returning now to FIG. 5, the face-top-and-bottom-position detecting process in the next step S13 is to execute the same process as the foregoing process on the horizontal edge and to detect the approximate position of eyebrows (upper end) and that of a mouth (bottom end) in the face. For example, the face-top-and-bottom-position detecting process (step S13) includes, as shown in FIG. 8, a histogram creating process (step S131), an under-eye-candidate detecting process (step S132), and a face-top-and-bottom-position calculating/recording process (step S133).

The histogram creating process (step S131) is to create a histogram by projecting values of individual pixels of the face image processed by the sobel filter for detecting a horizontal edge in the horizontal direction.

The under-eye-candidate detecting process (step S132) is to select candidates of histogram values corresponding to eyes, eyebrows, a mouth and the like, respectively, based on the histogram values.

The face-top-and-bottom-position calculating/recording process (step S133) is to detect top and bottom end positions (y-coordinates) of the face from the selected candidates, and record such coordinates in the RAM 24. Note that the top end position (y-coordinate) of the face can be, for example, detected as a position (y-coordinate) higher than the detected eyebrows by three pixels therefrom, and the bottom end position can be detected as a position (y-coordinate) lower than the detected mouth by three pixels therefrom.

Returning now to FIG. 4, upon completion of the face position determination process (step S1), the CPU 26 executes the exposure time correction process (step S2).

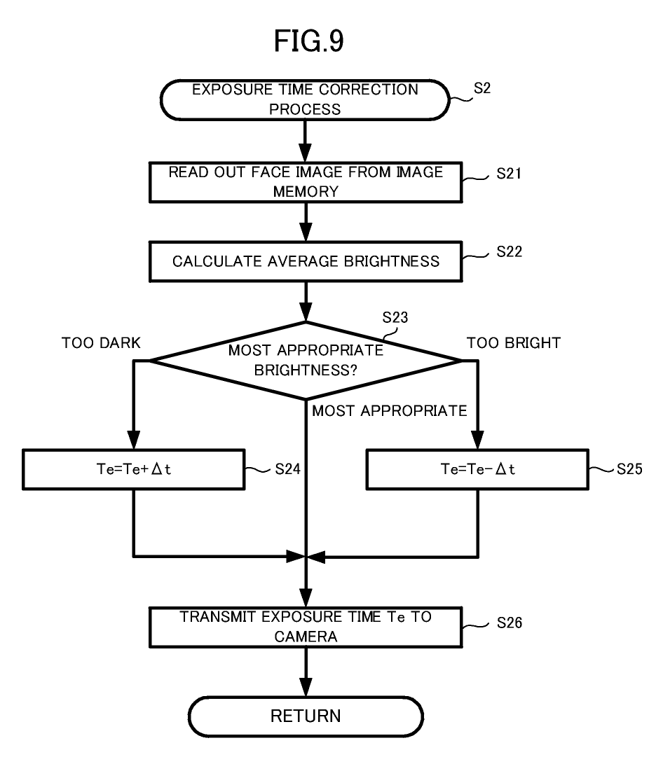

FIG. 9 shows the exposure time correction process (step S2) in detail.

First, the CPU 26 reads out an image of a face stored in the image memory 22 (step S21).

Next, the CPU 26 calculates an average brightness of the read-out face image (step S22).

More specifically, the CPU 26 calculates the average of the brightness of pixels of a face area, which can be specified by the coordinates of both ends of the face and those of top and bottom positions thereof (x-coordinates, y-coordinates) recorded in the face position determination process (step S1), among pixels configuring the face image. Note that the CPU 26 may add a weight W1 to the image of the face area and a weight W2 (<W1) to pixels of other areas, and calculate the brightness of the whole face image. Moreover, the face area may be divided into a plurality of sections, and the weight W1 may be set to divided area by divided area.

Next, the CPU 26 compares a calculated average brightness with the optimum brightness range recorded in the ROM 23, and determines whether or not the face image (precisely, the image of the face area) has an appropriate brightness in order to determine a facial direction and the condition of eyes (step S23).

When it is determined that the average brightness is within the optimum brightness range (step S23; optimum), the brightness of the face image is most appropriate to determine the facial direction and the condition of eyes and it is not necessary to correct the exposure time, so that the CPU 26 progresses the process to the step S26.

When it is determined that the average brightness is smaller than the optimum brightness range (step S23; too dark), the face image is too dark to do determination of the facial direction and the condition of eyes so that the analysis may become difficult. Accordingly, the CPU 26 adds the exposure correction amount Δt stored in the ROM 23 to the exposure time Tₑ of the camera 10, and stores such exposure time in the RAM 24 as a new exposure time Tₑ (step S24). Next, the CPU 26 progresses the process to the step S26.

When it is determined that the average brightness is larger than the optimum brightness range (step S23; too bright), the face image is too bright to do determination of the facial direction and the condition of eyes so that the analysis may also become difficult. Accordingly, the CPU 26 subtracts the exposure correction amount Δt stored in the ROM 23 from the exposure time Tₑ of the camera 10, and stores such exposure time in the RAM 24 as a new exposure time Tₑ (step S25). Next, the CPU 26 progresses the process to the step S26.

In the step S26, the CPU 26 reads out information indicating the exposure time Tₑ from the RAM 24, and transmits the read-out exposure time through the IF unit 21 to the CCD controller 12 in the camera 10 (step S26). Accordingly, the exposure time correction process (step S2) completes, and the exposure control process shown in FIG. 4 also completes.

The CCD controller 12 in the camera 10 receives an exposure time Tₑ which has been appropriately corrected through the exposure control process from the ECU 20 through the IF unit 13, and controls the image-pickup unit 11 to pick up an image at the received exposure time Tₑ. An image picked-up by the image-pickup unit 11 is transmitted to the ECU 20, and the exposure control process repeats.

The ECU 20 periodically determines a facial direction, the direction of eyes of a driver and the opening/closing status of eyes from a face image of the driver which is stored in the image memory 22, executes a driver alerting process by determining whether or not the driver is doing a hazardous driving, such as an inattentive driving and a drowsy driving, and alerting the driver.

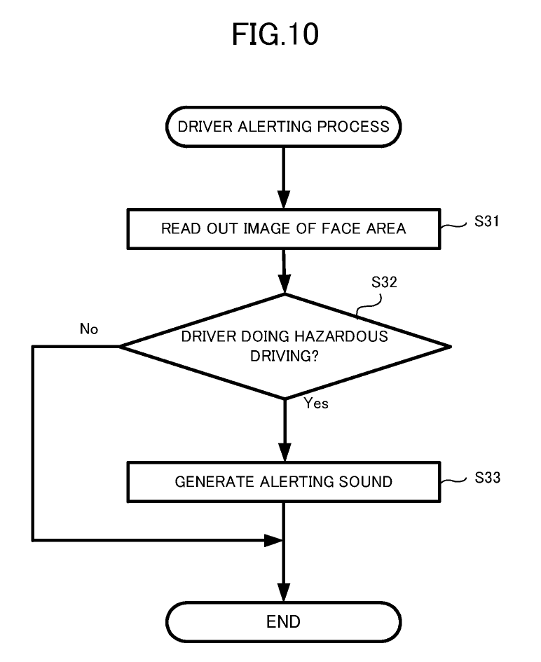

An example of the driver alerting process is shown in FIG. 10.

First, the CPU 26 of the ECU 20 reads out an image of a face area which is defined by both ends of a face and top and bottom position thereof all specified in the steps S126 and 5133 from face images of a driver stored in the image memory 22 (step S31). The image of the face area has an appropriate brightness for analysis through the foregoing exposure time correction process (step S2).

Next, the CPU 26 determines whether or not the driver is doing a hazardous driving, such as an inattentive driving and a drowsy driving, by analyzing the image of the face area (step S32).

The method of determining whether or not the hazardous driving is being carried out is arbitrary, and an arbitrary conventional technique can be applied to this process.

For example, a center position of a face is acquired by analyzing the image of a face area, and a face direction is determined from the position, and it is possible to determine that the driver is doing an inattentive driving if a difference between the face direction and the front direction of a vehicle is larger than or equal to a predetermined value, and this condition continues for more than or equal to a certain period.

Moreover, for example, eyes of a driver are checked by analyzing the image of a face area, and the direction of eyes is detected from the image of eyes, and it is possible to determine that the driver is doing an inattentive driving if a difference between the direction of eyes and the front direction of a vehicle is larger than or equal to a predetermined value, and the condition continues for more than or equal to a certain period.

Furthermore, the opening/closing status of eyes is detected from the image of eyes of a driver, and it is possible to determine that the driver is doing a drowsy driving if the closing status of eyes for more than or equal to a predetermined period is detected.

When it is determined that a driver is not doing a hazardous driving (step S32; No), it is not necessary to alert the driver, and the driver alerting process completes.

When it is determined that the driver is doing a hazardous driving (step S32; Yes), the CPU 26 generates an alert sound from the speaker 27 (step S33) in order to alert the driver, and the driver alerting process completes.

As explained above, according to the embodiment, every time the camera 10 transmits a picked-up face image to the ECU 20, the ECU 20 detects a face area from the transmitted face image, corrects an exposure time so as to have brightness most appropriate to determine a facial direction and the condition of eyes at the detected face area, notifies the corrected exposure time to the camera 10, and the camera 10 picks up an image of the face of a driver at the notified exposure time.

Consequently, it is possible to acquire a face image with an appropriate brightness even if a luminous environment changes. Moreover, it is possible to accurately determine a facial direction and the condition of eyes by analyzing the face image with the appropriate brightness, and to accurately determine whether or not the driver is doing a hazardous driving. Therefore, appropriate alerting against the hazardous driving is realized even if the luminous environment changes.

Note that the present invention is not limited to the foregoing embodiment, and can be changed and modified in various forms.

For example, in the foregoing embodiment, although the exposure time of the camera 10 is added/subtracted when the average brightness of the face area of the face image is not within the optimum brightness range (step S24, S25), it is possible to change the diameter of the aperture (opening) of the diaphragm 112 of the camera 10. That is, it is possible to control the diameter of the aperture (opening) of the diaphragm 112 to be narrowed by Δφ when the average brightness of the face area of an face image is higher than the optimum brightness range, and to control the diameter of the aperture (opening) of the diaphragm 112 to be widened by Δφ when the average brightness of the face area is lower than the optimum brightness range. Employment of such configurations enables controlling the lithographic exposure of the camera 10 so as to have an appropriate brightness when the average brightness of the face image is out of the optimum brightness range, and the same effect as those of the foregoing embodiment can be obtained.

Moreover, it is possible to correct the exposure time of the CCD 111 in the camera 10 and the diameter of the aperture (opening) of the diaphragm 112 in a combination manner.

Furthermore, in the foregoing embodiment, although the exposure time or the opening of the diaphragm 112 is added/subtracted by a certain time (Δt) or Δφ, respectively, when the average brightness of the face area is out of the optimum brightness range (step S24, S25), a method of correcting an amount of the exposure of the CCD 111 itself is arbitrary.

For example, in the foregoing embodiment, although a certain amount Δt or Δφ is corrected when the average brightness of the face image out of within the optimum brightness range, it is possible to employ a method of correcting a variable amount. For example, it is possible to correct an exposure time or the diameter of the aperture of the diaphragm by a value acquired from a formula a·e, a·e+b+·∫edt, a·e+b·∫edt+c·de/dt (a, b, and c are each a constant number) and the like based on a deviation e between an average brightness and an optimum brightness (a center value, an upper limit, or a lower limit thereof) under a PID control.

In the foregoing embodiment, although a part from eyebrows to the mouth and that from a left-end to a right-end in the face image are taken as a face area, and the condition of the driver is determined using the image of the face area, it is possible to use other areas of the face image to determine the condition of the driver. For example, an area from a forehead to a mouth of a face can be used as a face area. In this case, the exposure amount of the image-pickup unit 11 is corrected so as to make brightness of the area from the forehead to the mouth to be brightness appropriate for the analysis of the image.

Moreover, it is possible to use only the image of eyes to determine the condition of a driver. In this case, the exposure amount of the image-pickup unit 11 is corrected so as to make brightness around eyes in a face image to be brightness appropriate for analysis.

Furthermore, it is possible to set the whole face image to be an analysis object to determine the condition of the driver.

Moreover, in the foregoing embodiment, although the present invention is applied for a case of picking up an image of a driver, the present invention is not limited to this case, and is widely applicable to a process of picking up an image of humans, animals, dolls, robots and the like in an arbitrary scene.

Furthermore, a program which controls a computer to execute the foregoing process may be stored in an arbitrary computer-readable non-transitory tangible medium or a ROM through a network

It should be understood that the disclosed embodiment is just for exemplification and is not for limitation. The scope of the present invention is indicated not by the foregoing explanation but by the appended claims, and it is intended that equivalences and all changes within the scope of the invention should be included.

This application is based on Japanese Patent Application No. 2007-291069 filed on Nov. 8, 2007. The specification, claims, and whole drawings of Japanese Patent Application No. 2007-291069 are entirely incorporated herein by reference in this specification.

The present invention is useful as an in-vehicle image processing device which is connected to a camera that picks up an image of a face of a driver in a vehicle. In particular, the present invention is useful as the in-vehicle image processing device which is connected to the camera that is used under a condition that an image-pickup environment changes.

1-14. (canceled)

15. An in-vehicle image processing device comprising:
face image receiver which receives a picked-up image including a face of a driver from a camera;
face area detector which analyzes the image which is received by the face image receiver, and detects an area of a face which is included in the image;
brightness determiner which determines brightness of the face area which is detected by the face area detector;
camera controller which controls the camera in order to make brightness of a face area to be a predetermined level based on the brightness of the face area which is acquired by the brightness determiner; and
condition determiner which determines a condition of a driver using an image of a face area that the brightness of the face area which is detected by the face area detector is a predetermined level, and wherein
the camera periodically picks up an image of a driver and provides the picked-up image to the face image receiver, and
the camera controller controls an exposure amount of the camera in accordance with brightness determined by the brightness determiner.

16. The in-vehicle image processing device according to claim 15, further comprising alerter which outputs an alert based on a condition determined by the condition determiner.

17. The in-vehicle image processing device according to claim 15, wherein
the brightness determiner adds a heavier weight to a face area detected by the face area detector than other areas, and acquires a weighted average of brightness of an image.

18. The in-vehicle image processing device according to claim 15, wherein
the camera controller shortens an exposure time of the camera or narrows a diameter of a diaphragm of the camera when brightness determined by the brightness determiner is larger than a first reference value, and extends the exposure time of the camera or widens the diameter of the diaphragm of the camera when the brightness determined by the brightness determiner is smaller than a second reference value which is smaller than the first reference value.

19. The in-vehicle image processing device according to claim 16, wherein the alerter determines at least one of a facial direction, a direction of eyes, and an opening/closing status of eyes of a driver using an image of a face area which is detected by the face area detector, and generates an alert based on a determination result.

20. An image processing method comprising:
a face image receiving step of receiving a picked-up image including a face of a driver from a camera;
a face area detecting step of analyzing the received image, and detecting an area of a face which is included in the image;
a brightness determining step of determining brightness of the area of the detected face;
a camera control step of controlling the camera in order to make brightness of a face area of an image to be a predetermined level based on the determined brightness; and
a condition determining step of determining a condition of a driver using an area of a face that the detected brightness of the face area is a predetermined level, and wherein
the face image receiving step receives a picked-up image which is periodically picked-up by the camera, and
the camera control step controls an exposure amount of the camera in accordance with brightness determined by the brightness determining step.

21. The image processing method according to claim 20, wherein the brightness determining step is carried out by adding a heavier weight to a face area detected in the face area detecting step than other areas, and by acquiring a weighted average of brightness of an image.

22. The image processing method according to claim 20, wherein the camera control step shortens an exposure time of the camera or narrows a diameter of a diaphragm of the camera when brightness determined in the brightness determining step is larger than a first reference value, and extends the exposure time of the camera or widens the diameter of the diaphragm of the camera when the determined brightness is smaller than a second reference value which is smaller than the first reference value.

23. A computer-readable non-transitory tangible medium which stores a program controlling a computer to function as:
face image receiver which receives a picked-up image including a face of a driver from a camera;
face area detector which analyzes the image which is received by the face image receiver, and detects an area of a face which is included in the image;
brightness determiner which determines brightness of the face area which is detected by the face area detector;
camera controller which controls the camera in order to make brightness of a face area to be a predetermined level based on the brightness of the face area which is acquired by the brightness determiner; and
condition determiner which determines a condition of a driver using an image of a face area that the brightness of the face area detected by the face area detector is a predetermined level, and wherein
the face image receiver of the program receives a picked-up image which is periodically picked-up by the camera, and
the camera controller of the program controls an exposure amount of the camera in accordance with brightness determined by the brightness determiner.

24. The computer-readable non-transitory tangible medium according to claim 23, wherein the brightness determiner of the program adds a heavier weight to a face area detected by the face area detector than other areas, and acquires a weighted average of brightness of an image.

25. The computer-readable non-transitory tangible medium according to claim 23, wherein the camera controller of the program shortens an exposure time of the camera or narrows a diameter of a diaphragm of the camera when brightness determined by the brightness determiner is larger than a first reference value, and extends the exposure time of the camera or widens the diameter of the diaphragm of the camera when the brightness determined by the brightness determiner is smaller than a second reference value which is smaller than the first reference value.
